(19) United States
(12) Patent Application Publication
(10) Pub. No.: US 2013/0013518 A1
(43) Pub. Date: Jan. 10, 2013

(54) SYSTEMS, METHODS, APPARATUSES, AND COMPUTER PROGRAM PRODUCTS FOR COLLECTING RECYCLABLE GOODS

(75) Inventors: Roger Whitson, Duluth, GA (US); Jamie Cunningham, Roswell, GA (US); Olga Vila, Miami Beach, FL (US); Nancy Parmer, Roswell, GA (US)

(73) Assignee: UNITED PARCEL SERVICE OF AMERICA, INC., ATLANTA, GA (US)

(21) Appl. No.: 13/618,978

(22) Filed: Sep. 14, 2012

Related U.S. Application Data
(63) Continuation of application No. 12/254,581, filed on Oct. 20, 2008.

(51) Int. Cl. G06Q 50/28

(52) U.S. Cl. 705/308

(57) ABSTRACT

An apparatus and system are provided for facilitating a mechanism in which to collect and consolidate goods at a location for recycling. The apparatus includes a processor capable of defining a time period(s) and determining type(s) of recyclable goods and associating a defined time period(s) with one of the recyclable goods based on the type. A portion of the goods may be picked up from an entity upon expiration of the time period. The processor is also capable of receiving an indication that the portion of the goods are delivered to a location and consolidated with other goods of the same type. The other goods are delivered to the location from other entities and the processor is capable of determining whether the consolidated goods exceed a predetermined threshold and if so the processor is capable of generating an instruction to deliver the consolidated goods to a facility for recycling.

### CROSS-REFERENCE TO RELATED APPLICATIONS

This application is a continuation of U.S. application Ser. No. 12/254,581 filed Oct. 20, 2008 which is hereby incorporated herein in its entirety by reference.

### TECHNOLOGICAL FIELD

Embodiments of the invention relate generally to systems, methods, apparatuses and computer program products for collecting recyclable goods and more particularly relates to a mechanism of delivering retail goods and collecting unsold retail goods for recycling.

### BACKGROUND OF THE INVENTION

Currently, shipping companies are often hired by customers to pickup retail goods from a distribution point for delivery to a destination address. After receiving the retail goods, a merchant typically sells the retail goods for a period of time. Some retail goods may have an expiration date that is defined by the market or manufacturer. For example, print media such as magazines, newspapers, books and the like may have an expiration of one week, one month, or some other period of time depending on the content. For instance, many magazines are published for a given month and when the next magazine issue is published for the subsequent month, the previous month's issue is typically already outdated. For every ten magazine's printed, only three are actually sold. In other words, 70% of all printed magazines are unsold and require proper disposal. Given that print media such as for example magazines become outdated quickly, about one billion pounds (500,000 tons) of unsold magazines are typically returned from retailers to wholesalers for disposal each year. Similarly, newspapers are typically outdated from one day to the next since most newspapers are published and distributed on a daily basis. Unsold newspapers and books also contribute to the overall quantity of paper that needs to be disposed of annually.

Millions of unsold digital versatile discs (DVDs) and compact discs (CDs) are typically destroyed in a given year on behalf of companies such as movie and record companies to name a few. Electronic items may become outdated and obsolete by new technologies. For instance, many electrical devices such as personal digital assistants (PDAs), mobile phones, cameras, computers, etc. are often obsolete within six months or less due to advances in technology. Within the last year alone over 300,000,000 electronic items were destroyed. Additionally, clothes may go out of fashion very quickly due to seasonal changes, styles, trends or for other reasons.

To dispose of retail goods that remain unsold at or near their point of expiration or becoming obsolete or outdated, merchants typically reduce the price of unsold retail goods for a quick sale, hire a third party vendor to remove the goods, or simply throw away the unsold goods. However, these solutions are typically inadequate and do not provide a systematic approach to handling unsold retail products. For instance, quick sales of unsold retail goods at reduced prices often result in monetary losses to the merchant. Third party vendors hired to remove the unsold goods are often costly and inefficient. Similarly, throwing unsold retail goods away is inefficient and costly to the merchant and disposal may not be performed in a manner that is environmentally friendly.

Thus, a need exists to provide a systematic and efficient approach to properly consolidate or collect quantities of retail goods which may be tracked and to dispose of these goods in an environmentally friendly manner as well as to provide an efficient mechanism in which to generate revenue associated with the disposal of these goods via recycling.

### BRIEF SUMMARY OF THE INVENTION

One or more exemplary embodiments of the invention provide a mechanism to return products such as retail goods to hub locations and consolidation of the returned retail goods at strategic or regional hub locations. One or more of the exemplary embodiments may also facilitate disposal of the goods in an environmentally friendly manner such as by recycling which may serve to generate additional revenue resulting from the recycling of the retail goods.

For instance, one or more of the exemplary embodiments enable an entity (e.g., retailer, wholesaler, merchant and the like) to return retail goods (as referred to herein interchangeably as retail products), such as for example, unsold retail goods, to a carrier (e.g., shipping carrier). In this regard, the retail goods may be picked up by the shipping carrier at a defined time or upon the expiration of a defined time period, that is tracked by a processor of a device (e.g., server), from an initial delivery of the retail goods to the entity (e.g., one month from an initial delivery). In other words, upon the occurrence of the defined time or expiration of the defined time period, the processor may generate one or more instructions which instructs the personnel of the shipping carrier to pickup the retail goods. The goods may also be picked up by the carrier from the entity at any other suitable time. Once the carrier picks up the retail goods, a device such as server may receive an indication that the goods were delivered to one or more local hub locations of the carrier where one or more other goods or packages are handled for shipping and processing. At the local hub location(s), labels on the retail goods may be scanned by a device such as for example, a delivery information acquisition device, (DIAD) and the data obtained from the scan may be sent to the processor of the server which may use the data to track the retail products. The labels may be, but need not, United Parcel Service® (UPS) “Green Ship” labels designating that a product(s) is to be handled in an environmentally friendly manner such as by recycling the product(s). The sorted retail products may be taken to designated areas in the hub locations where these products may be loaded onto a vehicle, such as for example, a truck for delivery to a regional hub location.

The retail products sent from various local hub locations may then be delivered to a regional hub where the products may be scanned by a DIAD for tracking purposes, sorted, weighed and combined or consolidated in a designated area of the regional hub. Once the retail products are consolidated, the retail products may be loaded on a vehicle(s) such as for example a delivery truck(s) and sent to an entity or institution (e.g., a recycling company, also referred to herein a third party recycling company) for recycling. A device (e.g., server) of a regional hub may receive an indication that the consolidated retail products were delivered to the institution. Since the retail products received at the regional hub from various hub locations are consolidated, the likelihood of increasing the load capacity of the delivery vehicle is increased thereby saving money associated with delivering less than full loads.

The institution is able to utilize a DIAD to scan the retail products to determine their source of origin as well as obtain any other suitable information and based at least in the part on the weight of the retail products, an electronic device of the institution may calculate a payment that is owed to the carrier which delivered the retail goods to the institution.

As referred to herein recycling is defined as any process that transforms used materials into new materials or products or that reduces the consumption of energy and which may minimize the waste of useful recyclable materials. Retail products or goods that may be recycled herein may consist of materials such as paper, electronics (e.g., PDAs, cell phones, computers, etc.), glass, wood, textiles, plastics, fabrics, metals or any other suitable recyclable materials.

In one exemplary embodiment a corresponding method and computer program product are provided. The method and computer program product may include defining one or more times or time periods analyzed by a processor of a device and using the processor to determine a type(s) of recyclable goods. The recyclable goods may be associated with or linked to a time period(s) or a time(s) based on a determined type of recyclable goods. Each of the time periods or times maybe defined to be different based on different types of recyclable goods. The type of recyclable goods may be determined by a processor. The method and computer program products also include generating an instruction(s) for picking up at least a portion of the recyclable goods from a first entity upon expiration of a time period(s) or upon occurrence of a time(s) and a processor of a device may receive an indication that a portion of the goods were delivered to a first location. The portion of the goods are consolidated with other goods of the same type. The other goods are delivered to the location from one or more other entities, such as for example one or more hub locations. The method and computer program product also determines, via the processor, whether the consolidated goods exceed a predetermined threshold and if the processor determines that the predetermined threshold is reached or exceeded the processor arranges to deliver the consolidated goods to a facility that recycles the consolidated goods.

In yet another exemplary embodiment, an apparatus for facilitating collection and consolidation of goods for recycling is provided. The apparatus may include a processor configured to analyze one or more defined time periods or times and determine a type(s) of one or more recyclable goods. The processor is capable of associating a defined time period(s) or a defined time(s) with the recyclable goods based on the determined type of goods. The processor is also configured to analyze data and utilize the data to define each of the time periods or the times to be different based on different types of the recyclable goods. The processor is also configured to generate one or more instructions for picking up a portion of the recyclable goods from a first entity upon expiration of a defined time period(s) or upon occurrence of a defined time(s) and receive an indication that a portion of the recyclable goods are delivered to a first location and consolidated with other recyclable goods of the same type. The other goods are delivered to the location from one or more other entities. The processor is also configured to determine whether the consolidated goods exceed a predetermined threshold and in response to the predetermined threshold being reached or exceeded the processor may generate another instruction to deliver the consolidated goods to a facility that recycles the consolidated goods.

### BRIEF DESCRIPTION OF THE DRAWINGS

FIG. 1 is a schematic block diagram of an electronic device according to an exemplary embodiment of the invention;

FIG. 2 is a schematic block diagram of a system according to an exemplary embodiment of the invention;

FIG. 3 is a schematic block diagram of a system for collecting and consolidating goods for recycling according to an exemplary embodiment of the invention; and

FIG. 4 illustrates a flowchart for collecting and consolidating goods for recycling according to an exemplary embodiment of the invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

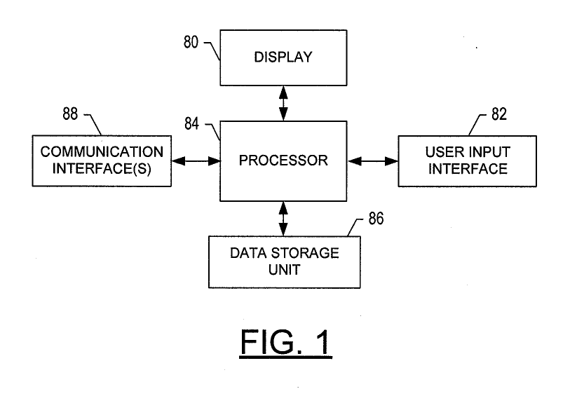

FIG. 1 illustrates a block diagram of an electronic device such as a client, server, computing device (e.g., personal computer (PC), computer workstation, laptop computer, personal digital assistant, etc.) or the like that would benefit from embodiments of the invention. The electronic device includes various means for performing one or more functions in accordance with exemplary embodiments of the invention, including those more particularly shown and described herein. It should be understood, however, that the electronic device(s) of the exemplary embodiments may include alternative means for performing one or more like functions, without departing from the spirit and scope of the invention. More particularly, for example, as shown in FIG. 1, the electronic device can include a processor 84 connected to a data storage unit 86. The data storage unit can comprise volatile and/or non-volatile memory, and typically stores content, data or the like. For example, the data storage unit may store content transmitted from, or received by, the electronic device. The data storage unit 86 is capable of storing data, including but not limited to, information related to pickup or delivery of goods, products or packages, information associated with defined time periods or days in which goods or packages are to be returned to a shipping carrier. It should be pointed out that information associated with the defined time periods and days may signify a time in which the goods, products or packages may be determined to be outdated and obsolete.

Also for example, the data storage unit 86 typically stores client applications, instructions or the like for executing the processor 84 to perform steps associated with operation of the electronic device in accordance with embodiments of the present invention. As explained below, for example, the data storage unit can store one or more client application(s) such as for example software or algorithms that may be executed by a processor. The software or algorithms that may be executed by the processor are associated with determining whether a defined time period associated with one or more products or goods has expired and upon expiration of the defined time period arranging for pickup of the goods by a shipping carrier. Arranging for pickup of the goods may, but need not, consist of automatically scheduling the shipping carrier to pick up the goods for delivery to one or more hubs and tracking the goods along a route in which the goods are consolidated with other similar goods at a regional hub which may be delivered to a entity for recycling. The software or algorithms that may be executed by a processor are also capable of calculating a payment that is owed to the shipping carrier as a result of recycling the goods.

In this regard, the software or algorithms, executed by a processor, herein facilitate consolidation of recyclable products on a much larger scale than would be otherwise achieved by not consolidating the materials.

The electronic device can include one or more logic elements for performing various functions as it executes one or more client application(s). The logic elements performing the functions can be embodied in an integrated circuit assembly including one or more integrated circuits integral or otherwise in communication with a respective network entity (i.e., computing system, client, server, etc.) or more particularly, for example, a processor 84 of the respective network entity.

In addition to the data storage unit 86, the processor 84 can also be connected to at least one interface or other device that displays, transmits, or receives data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) can include a first communication interface for connecting to a first network, and a second communication interface for connecting to a second network. In this regard, the electronic device is capable of communicating with other electronic devices over a network such as a Local Area Network (LAN), Wide Area Network (WAN), Wireless Wide Area Network (WWAN), the Internet, or the like. Alternatively, the communication interface can support a wired connection with the respective network. In addition to the communication interface(s), the interface(s) can also include at least one user interface that can include one or more earphones or speakers, a display 80, or a user input interface 82. The user input interface, in turn, can comprise any of a number of devices allowing the entity to receive data from a user, such as a microphone, a keypad, keyboard, a touch display, a joystick, image capture device, pointing device (e.g., mouse), stylus or other input device.

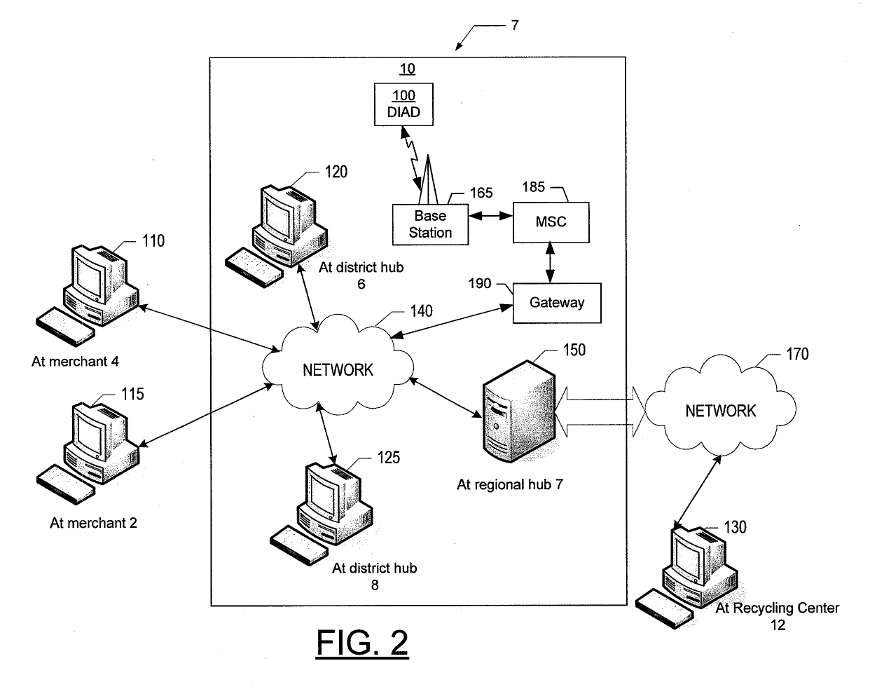

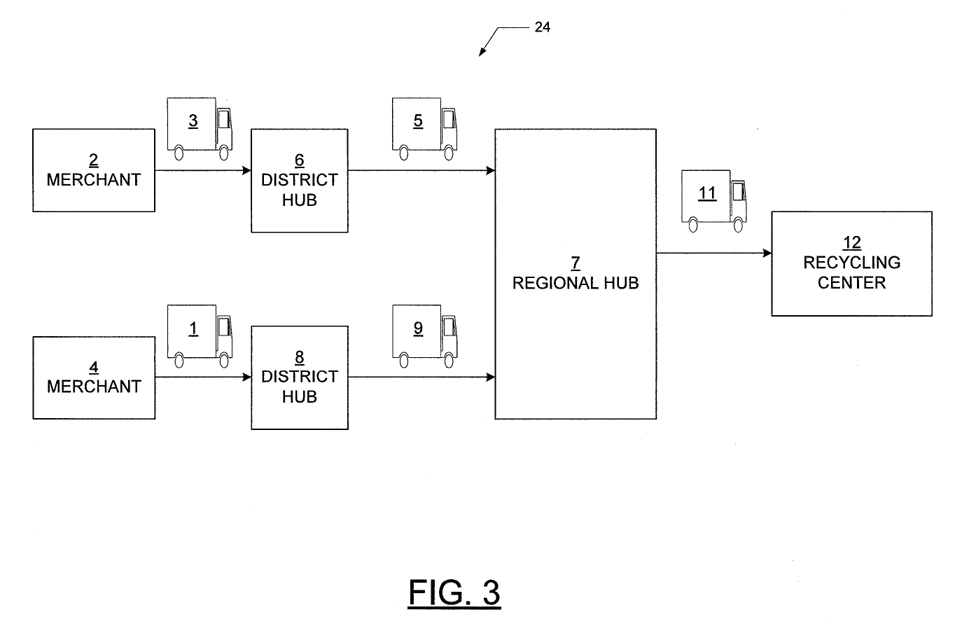

Reference is now made to FIG. 2, which is a block diagram of an overall system that would benefit from exemplary embodiments of the invention. It should be pointed out that the electronic devices 110, 115, 120, 125 and 130 (e.g., personal computers, laptops, personal digital assistants and the like) of FIG. 2 may comprise the elements of the electronic device illustrated in FIG. 1. As shown in FIG. 2, the electronic devices 110, 115, 120, 125 and 130 may be operated at entities such as merchant 2, merchant 4, district hub 6, district hub 8, and a recycling center 12, respectively. (See also FIG. 3) Each of the electronic devices 110, 115, 120 and 125 may access a server 150, or similar network entity, over a network 140, such as a wired or wireless local area network (LAN), a metropolitan network (MAN) or a wide area network (WAN) (e.g., the Internet). Similarly, electronic device 130 may access the server 150, or similar network entity over a network 170, such as a wired or wireless local area network (LAN), a metropolitan network (MAN) and/or a wide area network (WAN) (e.g., the Internet). In an exemplary alternative embodiment the network 140 may be the Internet. Although five electronic devices 110, 115, 120, 125 and 130 are shown in FIG. 2, it should be pointed out that any suitable number of electronic devices may be part of the system of FIG. 2.

Additionally, a delivery information acquisition device (DIAD) 100 including an antenna (not shown) for transmitting signals to a base station 165 or receiving signals from a base station 165 is shown in FIG. 2. The DIAD 100 is a mobile device and may be moved throughout the system 7. In this regard, the DIAD 100 may be located at the merchant 2, merchant 4, district hub 6, district hub 8, regional hub 7 and recycling center 12 at various times, or located in any other suitable place throughout the system 7. The base station 165 may consist of a cellular network, which includes elements required to operate the network, such as, for example, a mobile switching center (MSC) 185. The MSC 185 is capable of routing information to and from the DIAD 100. The MSC 185 can be coupled to a gateway 190, and the gateway 190 may be coupled to a network 140 (e.g., Internet). As such, the electronic devices 110, 115, 120, 125, and 130 as well as the server 150 can be coupled to the DIAD 100 via the networks 140 and 170. The DIAD 100 may include a scanning device executed by a processor, controller or the like that is capable of scanning information such as one or more codes, labels, (e.g., bar code labels) tracking numbers or the like. The information obtained by scanning may be transmitted to the server 150 which may store this information in its data storage unit 86 and which may upload this information to a web site. In an exemplary embodiment, the DIAD 100 may scan shipping labels or tracking numbers on retail products or goods and the information may be provided by the DIAD to the server 150, which may, but need not, upload the information to a web site. The retail products or goods may be unsold by a merchant such as for example merchants 2 and 4. It should be pointed out that although only one DIAD 100, base station 165, MSC 185 and gateway 190 is shown in FIG. 2 any suitable number of DIADs 100, base stations 165, MSCs 185 and gateways 190 may be within the system 7 without departing from the spirit and scope of the invention. Additionally, the electronic devices 120 and 125 at the district hubs 6, 8, respectively, the server 150 at the regional hub 7 as well as the network 140, DIAD 100, base station 165, MSC 185 and gateway 190 may be maintained and operated by an entity 10 (also referred to herein as a carrier (e.g., shipping carrier)).

Referring now to FIG. 3, a schematic block diagram of a system for collecting consolidated goods for recycling is illustrated. As shown in FIG. 3, the system 24 may include merchants 2 and 4, district hubs 6 and 8 as well as regional hub 7. The district hubs and the regional hub may be maintained by the entity 10. (See FIG. 2) Additionally, the system 24 may include a recycling center 12 and one or more vehicles (also referred to herein as trucks) 1, 3, 5, 9 and 11. It should be pointed out that while FIG. 3 shows five vehicles 1, 3, 5, 9, 11, two merchants 2, 4, two district hubs 6, 8, one regional hub 7 and one recycling center 12 that any suitable number of vehicles, merchants, district hubs, regional hubs and recycling centers may be in the system 24 without departing from the spirit and scope of the invention. Although not shown in FIG. 3, the electronic devices 110 and 115 of the merchants, and the electronic devices 120 and 125 of the district hubs 120, 125, and the electronic device 130 of the recycling center as well as the server 150 of the regional hub may be electronically coupled to each other via the networks 140 and 170 in the manner discussed above with respect to FIG. 2.

It should be pointed out that merchants may be referred to herein interchangeably as wholesalers, retailers and the like without departing from the spirit and scope of the invention. In this regard, each of the merchants 2 and 4 may produce, buy and/or sell goods and/or services. In this regard, the merchants 2 and 4 may sell goods, products, commodities and the like to consumers or other businesses. In an exemplary embodiment, the goods and/or products may be retail goods. The retail goods may, but need not, be magazines, newspapers, books, DVDs, CDs, electrical devices (e.g., mobile phones, PDAs, cameras, etc.), clothes, tires, furniture or any other recyclable goods.

The merchants 2 and 4 may communicate with the shipping carrier 10 for delivery of one or more retail goods or products. This communication may, but need not, be sent from an electronic device (e.g., electronic device 110) of a merchant (e.g., merchant 4) to the server 150 via network 140. For example, the communication may be sent via the Internet and the communication may be in the form of a request, message (e.g., email, short message service (SMS) message, multimedia messaging service (MMS)) or the like). It should be pointed out however that any other suitable mechanism (e.g., phone call, mail orders, etc.) of communicating with the shipping carrier for arranging delivery of retail goods may be utilized by the merchant. Upon receipt of the request or message by the processor 84 of the server 150, the processor may identify the type of retail goods (e.g., magazines) identified in the request and based on the identification of the retail goods, the processor 84 of the server 150 may execute software or algorithms stored in its data storage unit which define a time (e.g., a given day) or defined time period that is associated with the requested retail goods. The processor of the server 150 may determine the identity of the goods requested by using optical character recognition (OCR) or any other suitable mechanism. For instance, the processor of the server 150 may evaluate the text of the request or message and determine that the type of retail goods (e.g., magazines, electronic devices, books, etc.) being requested.

The processor of the server 150 may analyze defined data (e.g., software or algorithms) that is associated with the time or defined time period which indicates that the retail goods are determined to be obsolete or outdated upon the expiration of the defined time period or at the defined time (e.g., a given day which may be in the future). The defined time and time periods may be different based on the type of retail products that are identified by the processor of the server 150. For purposes of illustration and not of limitation, if the processor of the server determines that the retail products requested are magazines, the processor of the server is capable of setting a defined time period of one month (or any other suitable time period) from an initial delivery date of the retail products to the requesting merchant. As another example, if the processor of the server 150 determines that the retail products requested are electrical devices such as for example digital cameras, the processor of the server is capable of setting a defined time period of five months (or any other suitable time period) from an initial delivery date of the retail products to the requesting merchant (e.g., merchant 2).

The processor 84 of the server 150 may also analyze defined data (e.g., software or algorithms) and associate the defined data with defined times and defined time periods which indicate to the processor of the server that upon the expiration of the defined time period(s) or at the defined time, the shipping carrier may pick up goods designated to be returned by the merchant(s). These goods may, but need not, be unsold retail goods that were delivered to the merchant (e.g., merchant 2) by the shipping carrier 10.

Once the processor of the server 150 examines the request or message sent by the electronic device 110 of the merchant (e.g., merchant 4) for delivery of retail products, the shipping carrier 10 may pick up the requested retail goods from a distribution point (not shown) for delivery of the retail goods to the requesting merchant(s). In this regard, the shipping carrier may pick up the requested retail goods from the distribution point on the basis of personnel evaluating a work order request generated by the processor of the server 150 instructing the personnel of the shipping carrier to pickup the requested retail goods from the distribution point. It should be pointed out that the distribution point may be maintained and operated by the shipping carrier 10. Alternatively, the distribution point may be maintained by a third party entity. For instance, in an alternative exemplary embodiment, the distribution point may be maintained by a wholesaler which may sell goods or products to the merchants 2 and 4. The wholesaler may, but need not, buy the goods or products directly from a manufacturer and the purchase of the goods or products may be made in large quantities (e.g., bulk). It should be pointed out that there may be more than one distribution point in the system 24.

At the distribution point, one or more labels may be placed on or included in one or more packages containing the requested retail products (e.g., magazines). The labels may include one or more tracking numbers that may be utilized to identify the location of the packages. Additionally, the label may include information (e.g., code information such as barcode data) indicating the type of retail products and the distribution point (i.e., the source) from which the retail products were picked up. The label may also include information specifying that the retail products are to be returned for delivery to the shipping carrier 10 upon the expiration of a defined time period or at a given time. The retail products to be returned to the shipping carrier 10 may be unsold retail products or goods. Additionally, information on the labels may specify that the products are to be returned for delivery to the shipping carrier 10 upon the expiration of the defined time period (or upon reaching the defined time) and are to be recycled. In this regard, the labels having information indicating that the products are to be returned for delivery to the shipping carrier 10 and which are designated for recycling may be “Green Ship” labels signifying that the contents of the packages are being handled in an environmentally friendly manner.

Upon delivery, by the shipping carrier 10, of the retail products from the distribution point to the requesting merchant(s) (e.g., merchant 2), personnel of the shipping carrier 10 may utilize the DIAD 100 to scan the label(s) of the packages containing the retail products and the DIAD 100 may send information to the processor of the server 150 indicating that the retail products have been delivered to the requesting merchant from the distribution point. Upon receipt of the information obtained from scanning the labels, the processor 84 of the server 150 is capable of determining the time in which the retail goods were delivered to the merchant and starting a defined time period associated with the retail goods, in a manner analogous to that discussed above. For purposes of illustration and not of limitation, the processor of the server 150 is able to determine the type of retail products from the information received by the DIAD 100 upon scanning the packages and in response to the processor of the server 150 determining that the product type consists of magazines, for example, the processor is capable of starting a time which counts the duration of a month, for example, corresponding to a defined time period, and in response to the time period expiring, the processor of the server is capable of generating instructions (e.g., a work order request) for personnel of the shipping carrier 10 to pickup retail products from the merchant that are designated for return. All or a portion of the retail products designated for return may be unsold retail products. As another example, the processor of the server 150 is able to determine the type of retail products from the information received by the DIAD 100 upon scanning the packages and when the processor of the server 150 determines that the product type consists of electrical devices (e.g., cameras), for example, the processor 84 is capable of identifying a defined time (e.g., the first day of the following five months) in which the packages are to be returned to the shipping carrier 10 if they are not sold by that time.

Upon expiration of the defined time period or at the defined time (e.g., a given day), the processor of the server 150 may send the electronic device (e.g., electronic device 110) of the merchant (e.g., merchant 4) a message which contains information requesting the merchant to identify whether any retail products are to be returned to the shipping carrier upon expiration of the defined time period or at the defined time. In this regard, the processor of the electronic device of the merchant may send a reply message via the communication interface 88 to the server 150 indicating whether retail products are to be returned or not. If the message (e.g., e-mail, SMS, MMS, etc.) sent from the electronic device of the merchant to the processor of the server 150 contains data indicating that the retail products are to be returned to the shipping carrier 10, the shipping carrier sends appropriate personnel to the merchant to pick up the products to be returned. It should be pointed out that the merchant (e.g., merchant 4) may communicate with the shipping carrier regarding whether retail products are to be returned to the shipping carrier according to any other suitable manner without departing from the spirit and scope of the invention. For instance, this communication may occur via a telephone call between personnel of the merchant and personnel of the shipping carrier.

In an alternative exemplary embodiment, upon expiration of the defined time period or at the defined time, the processor of the server 150 may generate an instruction instructing personnel of the shipping carrier to pickup retail goods to be returned to the shipping carrier prior to receipt of a message or communication from the merchant indicating that there are retail products to be returned to the shipping carrier.

Upon arrival at the merchant(s) (e.g., merchants 2 and 4), the shipping carrier may utilize a vehicle (e.g., truck 3) to load the retail products to be returned to the shipping carrier. As pointed out above, these retail products may, but need not, be unsold products. The shipping carrier may utilize the vehicle to deliver the retail products to a district hub (e.g., district hub 6) of the shipping carrier. For instance, a truck 3 carrying retail goods that are picked up from a merchant (e.g., merchant 2) may deliver the goods to a district hub 6. In like manner, a truck 1 carrying retail goods that are picked up from a merchant (e.g., merchant 2) may deliver the goods to a district hub 8. The district hub may but need not be the closest hub location to the merchant. The district hubs of the exemplary embodiments may be facilities for processing, handling and sorting one or more packages. Additionally, other vehicles (not shown) may deliver packages to/from the district hubs without departing from the spirit and scope of the invention. For instance, another vehicle (e.g., truck) carrying retail products picked up from another merchant (not shown) may deliver the retail products to the district hub (e.g., district hub 6) The retail products may be the same type of retail products (e.g., magazines) as the retail products picked up from a merchant such as for example merchant 2.

At the district hubs, the packages containing the retail products picked up from the merchant may be unloaded from the vehicles and scanned by DIAD 100 in a manner analogous to that discussed above and the information obtained from the scan may be saved in the data storage unit 86 of the electronic device (e.g., electronic device 120 at district hub 6). In this regard, the processor of the server 150 may scan a Green Ship label on the packages and the scanned information may identify the merchant from which the packages were picked up as well as the type of the retail product (e.g., magazines, electrical devices, etc.) and may signify that the retail products are to be handled in an environmentally friendly manner such as recycling. Additionally, the scanned information may include any other suitable information. Moreover, the information obtained from the scan may be sent to the processor of the server 150 which may store the information in its data storage unit 86 and may make the information accessible to all the electronic devices of the system 7 via the network 140 or the network 170.

It should be pointed out that the retail products that are of the same type (e.g., magazines, electrical devices, etc.) may be sorted at the district hubs and may be placed in designated areas, packaged and labeled (e.g., labeled using Green Ship labels) and loaded onto vehicles (e.g., trucks 5 and 9) for delivery to a regional hub 7. In this regard, the retail products obtained from various merchants may be consolidated and delivered to the regional hub 7 by the vehicles. Since the retail products from various merchants may be combined or consolidated at the district hubs 6 and 8, the load space of the vehicles carrying the retail products to the regional hubs is more fully utilized which saves costs due to inefficiencies associated with delivery of retail products that do not completely utilize the load space of the vehicles.

As shown in FIG. 3, the trucks 5 and 9 may deliver the packages containing retail products that were picked up from merchants and consolidated at the district hubs (e.g., district hubs 6 and 8) and deliver the retail products to the regional hub 7. At the regional hub 7, the packages may be unloaded and sorted. Additionally, the labels of the packages may be scanned via a DIAD 100 and the information obtained from the scan may be stored in the data storage unit of the server 150 and accessible by all of the electronic devices of the system 7 in a manner analogous to that discussed above. In an exemplary embodiment, the labels may be Green Ship labels which contain information indicating that the contents (e.g., retail products) of the packages are to be handled in an environmentally friendly manner such as for example by recycling the contents.

Furthermore, packages containing retail products that are of a similar type may be placed in designated areas of the regional hub 7 and may be loaded on a vehicle such as truck 11. For instance, the packages delivered by the truck 5 may consist of retail products such as for example magazines and the packages delivered by the truck 9 may also consist of retail products such as for example magazines or any other suitable retail products. Since the retail products delivered by the trucks 5 and 9, in this example, are of the same type, these retail products may be placed in a designated area(s) of the regional hub, consolidated or combined and loaded on a vehicle such as truck 11. Given that packages containing the same types of retail products obtained from one or more district hubs may be consolidated and combined at the regional hub 7, the load space of a vehicle such as truck 11 carrying the retail products is more efficiently utilized since there is more volume of packages to load than there may be in cases where the packages were not consolidated which could result in trucks that are only partially full thereby increasing costs to an entity. For instance, in an alternative exemplary embodiment, the load space of the truck (e.g., truck 11) may be required to be a certain percentage full (e.g., 90% or more full) before the packages containing the retail products may be delivered to the regional hub 7. Otherwise, the retail products may be maintained at the regional hub and consolidated with other retail products that are delivered at a subsequent time. Alternatively, the weight of the retail products loaded on the truck may be required to be within 5% of 42, 500 lbs. before the truck delivers the packages containing the consolidated retail products to the recycling center 12. The processor of the server 150 may monitor the percentage in which the load space of the truck is full on the basis of the number packages that are being scanned once they are loaded on the truck or according to any other suitable mechanism. Additionally, the processor of the server 150 may monitor the weight of the retail products loaded on the truck. In this regard, the processor of the server may be connected to an input of an electronic weighing mechanism (not shown) that is capable of determining the weight of packages loaded on the truck.

The vehicle such as truck 11 carrying the packages containing the retail products that were combined or consolidated at the regional hub 7 may be delivered to a recycling center 12. At the recycling center 12, the packages may be unloaded from truck 11 and the labels (e.g., Green Ship labels) on the packages may be scanned by DIAD 100. Information obtained from the scan may identify the type of retail products (e.g., magazines) contained within the packages and may identify the merchant(s) from which the shipping carrier picked up the retail products. For instance, information contained on a bar code of the packages may identify that the contents of the packages came from merchant 2 or merchant 4 for example. It should be pointed out that the information obtained from the scan may be stored in the data storage unit 86 of the electronic device 130 at the recycling center 12 and may be sent to the server 150 and electronic devices 110, 115, 120, and 125 via networks 170 and 140. Additionally, the retail products contained within the packages may be weighed at the recycling center 12. In this regard, the processor of the electronic device 130 may obtain data indicating the weight of the retail products and may identity the weight of retail products picked up from a particular merchant.

For purposes of illustration and not of limitation, the processor of the electronic device 130 may determine that 5,000 lbs. of retail products were picked up from a merchant such as for example merchant 2, whereas 3,000 lbs. of retail products were picked up from another merchant such as for example merchant 4. Additionally, the processor of the electronic device 130 may calculate a fee that is due to the shipping carrier 10 based on the weight of the retail products delivered to the recycling center 12. For instance, the fee due to the shipping carrier 10 may be determined based on a flat rate (e.g., 4.5 cents) per pound of the retail products. Additionally, this rate may be different depending on the type of product. For example, the rate may be 5 cents per pound for retail products such as magazines, book, newspapers and other paper based goods but may be 10 cents per pound for electrical devices or any other suitable rates. In this regard, the processor of the electronic device 130 may generate a credit (e.g., an amount of money) to be sent to the shipping carrier 10. In an exemplary embodiment, a monetary amount associated with the credit may be sent by the processor of the electronic device 130 (of the recycling center) to the processor of the server 150 which may maintain an account of the shipping carrier 10 and the credit may be applied to the account. However, it should be pointed out that the recycling center 12 may send the shipping carrier the amount owed according to any other suitable techniques. For instance, the recycling center 12 may send a check for the monetary amount of the retail products to the shipping carrier 10. In an exemplary embodiment, the check may be sent to the regional hub 7 or any other suitable facility of the shipping carrier 10.

It should be pointed out that the recycling center 12 may recycle the retail products according to any suitable known mechanisms. For purposes of illustration and not of limitation, if the retail products are magazines, personnel of the recycling center 12 may open the packages and separate the magazines from the cardboard boxes that the retail products are shipped within. The magazines and cardboard boxes may be shredded and compressed for recycling. The recycling of the magazines and the cardboard boxes may, but need not, occur in different processes. Additionally, the processor of the electronic device 130 may generate a certificate that is sent to the processor of the server 150 and the certificate may contain data indicating that the retail products delivered from the regional hub 7 to the recycling hub 12 have been recycled.

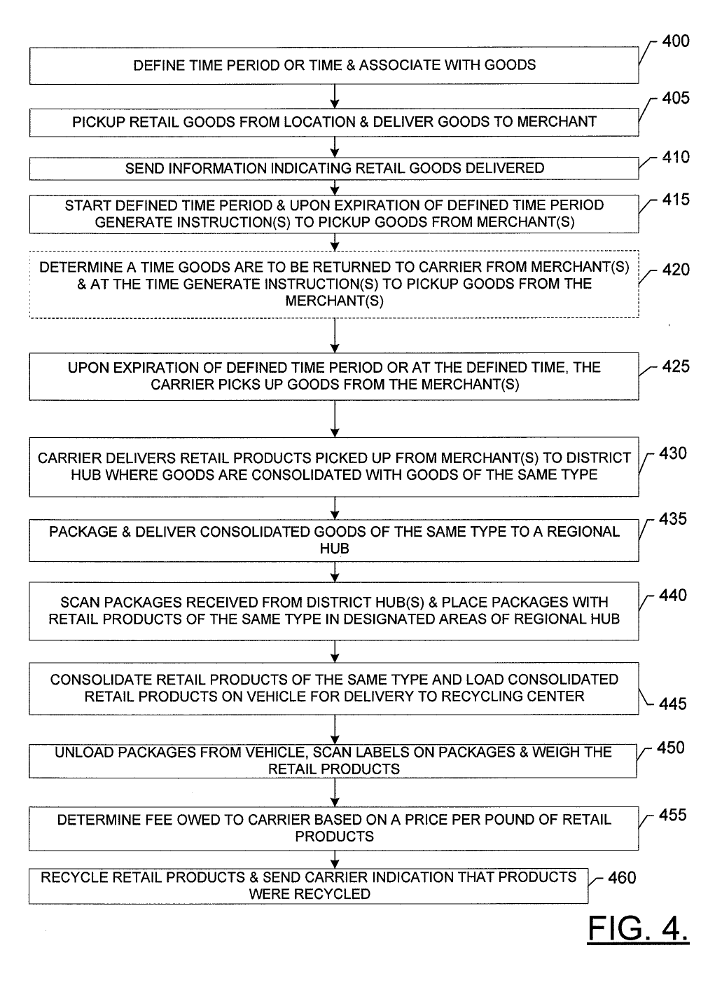

Referring now to FIG. 4 a flowchart for collecting and consolidating goods for recycling according to an exemplary embodiment is provided. At operation 400, a processor of a device such as server 150 may analyze a defined time period(s) or a defined time(s) that is associated with retail goods. The defined time period(s) or the defined time(s) may be different based on a type of the retail goods. At operation 405, a shipping carrier may pickup retail goods from a location (e.g., a hub location or at a facility maintained by a wholesaler or the like) and deliver the goods to a merchant (e.g., merchant 2). At operation 410, personnel of the shipping carrier may utilize a device such as DIAD 100 to send a device, such as a server 150, information indicating that the retail goods have been delivered to the requesting merchant. At operation 415, the processor of the server may start a defined time period(s) and upon expiration of the defined time period(s), the processor of the server may generate an instruction(s) informing personnel of the shipping carrier to pickup goods to be returned from the merchant(s). Optionally, at operation 420, the processor of the server may determine a defined time(s) (e.g., a given day) that retail goods are to be returned to the shipping carrier from the merchant and upon occurrence of the defined time(s), the processor of the server may generate an instruction(s) informing personnel of the shipping carrier to pickup goods to be returned from the merchant(s). At operation 425, in response to the defined time period(s) expiring or if the defined time(s) has occurred, the processor of the server may generate an instruction instructing personnel of the shipping carrier to pick up goods to be returned from by the merchant(s). At operation 430, the shipping carrier delivers the retail products picked up from the merchant(s) to a district hub, where the retail goods may be scanned by a DIAD and placed in designated areas of the district hub (e.g., district hub 6) and consolidated with retail goods of the same type that may also be delivered to the district hub from other merchants. At operation 435, the retail goods of the same type may be packaged and delivered to a regional hub 7. The packages may contain labels (e.g., Green Ship labels). At operation 440, the packages containing retail products delivered from the district hubs (e.g., district hubs 6 and 8) may be scanned by a DIAD and retail products of the same type may be placed in designated areas of the regional hub 7. At operation 445, the retail products of the same type may be combined or consolidated and loaded on a vehicle (e.g., truck 11) for delivery to a recycling center 12. In response to the retail products being the same type and consolidated and loaded on the vehicle, a device (e.g., electronic devices 120 or 125 or DIAD 100) may send the processor of the server 150 an indication that the retail products were consolidated and loaded on the vehicle. At operation 450, the packages may be unloaded from the vehicle, the labels (e.g., Green Ship labels) on the packages may be scanned by the DIAD and the retail products may be weighed by an electronic weighing scale or by another suitable technique. At operation 455, a fee owed to the shipping carrier may be determined by the processor of the electronic device (e.g., electronic device 130) based on a price per pound (e.g., 4.5 cents) of retail products and a monetary amount associated with the fee may be paid to the shipping carrier in a manner analogous to that discussed above. At operation 460, the retail products may be recycled by the recycling center 12 and an electronic device (e.g., electronic device 130) at the recycling center 12 may send a device (e.g., server 150) of the shipping carrier an indication (e.g., certificate) that the retail products were recycled.

It should be understood that each block or step of the flowchart, shown in FIG. 4 and combination of blocks in the flowchart, can be implemented by various techniques, such as hardware, firmware, or software in memory including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving a request to pickup goods from an entity at a defined time to dispose of the goods on behalf of the entity;
receiving a first indication that the goods are delivered to a first location by a shipping carrier in response to the pickup of the goods from the entity;
tracking the delivery of the goods being delivered to an institution for disposal of the goods in response to receipt of information indicating that respective labels of the goods are scanned at the first location;
receiving another indication that the goods are delivered to the institution; and
applying, via a processor, an amount of money to an account of the shipping carrier in response to receiving a message from the institution indicating a calculated fee that is owed to the shipping carrier in response to delivery of the goods to the institution.

2. The method of claim 1, wherein the calculated fee is determined based in part on a weight of the goods delivered to the institution.

3. The method of claim 1, wherein the calculated fee is determined based in part on a rate per pound of the goods.

4. The method of claim 3, wherein the rate is determined based in part on a determined type of the goods.

5. The method of claim 1, wherein the delivery of the goods to the institution enables the institution to dispose of the goods by recycling the goods.

6. The method of claim 5, further comprising:
receiving a message from the institution indicating that the institution recycled the goods.

7. The method of claim 1, wherein prior to receiving another indication that the goods are delivered to the institution, the method further comprises:
consolidating the goods with another set of goods of the same type at a second location of the shipping carrier and wherein the delivery to the institution comprises the goods and the set of goods.

8. An apparatus comprising:
at least one processor; and
at least one memory including computer program code configured to, with the at least one processor, cause the apparatus to perform at least the following:
receive a request to pickup goods from an entity at a defined time to dispose of the goods on behalf of the entity;
receive a first indication that the goods are delivered to a first location by a shipping carrier in response to the pickup of the goods from the entity;
track the delivery of the goods being delivered to an institution for disposal of the goods in response to receipt of information indicating that respective labels of the goods are scanned at the first location;
receive another indication that the goods are delivered to the institution; and
apply an amount of money to an account of the shipping carrier in response to receiving a message from the institution indicating a calculated fee that is owed to the shipping carrier in response to delivery of the goods to the institution.

9. The apparatus of claim 8, wherein the calculated fee is determined based in part on a weight of the goods delivered to the institution.

10. The apparatus of claim 8, wherein the calculated fee is determined based in part on a rate per pound of the goods.

11. The apparatus of claim 10, wherein the rate is determined based in part on a determined type of the goods.

12. The apparatus of claim 8, wherein the delivery of the goods to the institution enables the institution to dispose of the goods by recycling the goods.

13. The apparatus of claim 12, wherein the memory and computer program code are further configured to, with the processor, cause the apparatus to:
receive a message from the institution indicating that the institution recycled the goods.

14. The apparatus of claim 8, wherein prior to receive another indication that the goods are delivered to the institution, the memory and computer program code are further configured to, with the processor, cause the apparatus to:
facilitate consolidation of the goods with another set of goods of the same type at a second location of the shipping carrier and wherein the delivery to the institution comprises the goods and the set of goods.

15. A computer program product comprising at least one non-transitory computer-readable storage medium having computer-readable program code portions stored therein, the computer-readable program code portions comprising:
program code instructions configured to cause receipt of a request to pickup goods from an entity at a defined time to dispose of the goods on behalf of the entity;
program code instructions configured to cause receipt of a first indication that the goods are delivered to a first location by a shipping carrier in response to the pickup of the goods from the entity;
program code instructions configured to track the delivery of the goods being delivered to an institution for disposal of the goods in response to receipt of information indicating that respective labels of the goods are scanned at the first location;
program code instructions configured to cause receipt of another indication that the goods are delivered to the institution; and
program code instructions configured to apply an amount of money to an account of the shipping carrier in response to receiving a message from the institution indicating a calculated fee that is owed to the shipping carrier in response to delivery of the goods to the institution.

16. The computer program product of claim 15, wherein the calculated fee is determined based in part on a weight of the goods delivered to the institution.

17. The computer program product of claim 15, wherein the calculated fee is determined based in part on a rate per pound of the goods.

18. The computer program product of claim 17, wherein the rate is determined based in part on a determined type of the goods.

19. The computer program product of claim 15, wherein the delivery of the goods to the institution enables the institution to dispose of the goods by recycling the goods.

20. The computer program product of claim 15, wherein prior to cause receipt of another indication that the goods are delivered to the institution, the computer program product further comprises:
program code instructions configured to facilitate consolidation of the goods with another set of goods of the same type at a second location of the shipping carrier and wherein the delivery to the institution comprises the goods and the set of goods.
